(19) United States
(12) Patent Application Publication
(10) Pub. No.: US 2004/0073412 A1
(43) Pub. Date: Apr. 15, 2004

(54) Negative bias temperature instability effect modeling

(76) Inventors: John de Quincey Walker, Colorado Springs, CO (US); SangJune Park, Colorado Springs, CO (US); Erhong Li, Sunnyvale, CA (US); Sharad Prasad, Pleasanton, CA (US)

Correspondence Address: LSI LOGIC CORPORATION, 1621 BARBER LANE, MS: D-106 LEGAL, MILPITAS, CA, 95035, US

(21) Appl. No.: 10/264,876

(22) Filed: Oct. 4, 2002

(51) Int. Cl. G06F 17/10

(52) U.S. Cl. 703/2

(57) ABSTRACT

An improvement to a method of modeling an integrated circuit, by accounting for the negative bias temperature instability effects of both threshold voltage and carrier mobility on Idsat. When the integrated circuit is an alternating current device, the negative bias temperature instability effects are calculated according to:

$$Parametric\_shift = a \cdot \frac{1}{{f}^{α \cdot {( 1 - R )}^{β}}} \cdot {t}^{m} \cdot exp ( - \frac{{E}_{A}}{kT} ) \cdot exp ( b \cdot Vg )$$

where a, m, −Ea, and b are constants for effects of time, temperature, and gate voltage on parametric shift, obtained by curve fitting to empirical data, Ea is activation energy, k is Boltzmann's constant, and t, T and V_{g} are time, temperature and gate voltage respectively, and f and R are frequency and duty cycle respectively.

### FIELD

This invention relates to the field of integrated circuit fabrication. More particularly, this invention relates to designing integrated circuits, most especially PMOS devices in mixed signal, analog, or I/O circuits.

### BACKGROUND

When a PMOS device is subjected to different operational conditions, a shift in certain operating parameters, such as threshold voltage, can often be observed. For example, when a PMOS device is operated at a given temperature and gate bias for a given time, there tends to be a shift, or degradation, in the threshold voltage of the device. This effect is generally referred to as negative bias temperature instability. The effect is particularly pronounced in devices with nitrided gates, and may be caused by the trapping of charges at the gate oxide interface. This phenomenon tends to have a large effect on analog circuit elements, such as source coupled MOSFET pairs. However, the effect tends to be transient, and the threshold voltage returns to about its original value when the charged states de-trap after the gate stress is removed.

When designing an integrated circuit, issues such as negative bias temperature instability should be accounted for, or the integrated circuit may not function properly. Certain integrated circuits, such as mixed signal cells, analog circuits, and I/O circuits may not function at all. In addition, the effects of negative bias temperature instability tend to be different for alternating current devices than they are for direct current devices. However, if the impact of the negative bias temperature instability effect could be accurately accounted for, then the resultant shift of the parameters can be used in modeling programs such as SPICE, and design modifications can be made to the devices such that they will operate properly in anticipated situations, without placing too strict a set of constraints on the design parameters. However, any predictive modeling that may be developed for the effects of negative bias temperature instability would preferably account for the differences between direct current devices and alternating current devices.

What is needed, therefore, is a system for modeling the effects of relatively independent parameters such as time, temperature, and bias on device operation parameters for both direct current integrated circuits and alternating current integrated circuits.

### SUMMARY

The above and other needs are met by an improvement to a method of modeling an integrated circuit, by accounting for the negative bias temperature instability effects of both threshold voltage and carrier mobility on Idsat. In a first preferred embodiment the integrated circuit is an alternating current device and the negative bias temperature instability effects are calculated according to:

$$Parametric\_shift = a \cdot \frac{1}{{f}^{α \cdot {( 1 - R )}^{β}}} \cdot {t}^{m} \cdot exp ( - \frac{{E}_{A}}{kT} ) \cdot exp ( b \cdot Vg )$$

where a, m, −Ea, and b are constants for effects of time, temperature, and gate voltage on parametric shift, obtained by curve fitting to empirical data, Ea is activation energy, k is Boltzmann's constant, and t, T and V_{g} are time, temperature and gate voltage respectively, and f and R are frequency and duty cycle respectively.

In a second preferred embodiment the integrated circuit is a direct current device and the negative bias temperature instability effects are calculated according to:

$$Parametric\_shift = a \cdot {t}^{m} \cdot exp ( - \frac{{E}_{A}}{kT} ) \cdot exp ( b \cdot Vg )$$

where a, m, −Ea, and b are constants for effects of time, temperature, and gate voltage on parametric shift, obtained by curve fitting to empirical data, Ea is activation energy, k is Boltzmann's constant, and t, T and V_{g} are time, temperature and gate voltage respectively.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a schematic diagram of a source coupled pair of MOSFETs,

FIG. 2 is a data plot of the standard deviation of NMOS threshold voltage against the inverse square root of gate area,

FIG. 3 is a data plot of the yield of seven to ten bit analog to digital converters as a function of standard deviation of input transistor pair mismatch,

FIG. 4 is a data plot providing the definitions of frequency and duty cycle,

FIG. 5 is a data plot depicting parameter shift along stress time with relaxation of stress and without relaxation of stress,

FIG. 6 is a data plot of gate voltage against current density, and

FIG. 7 is a data plot of current saturation degradation against stress time as measured and as predicted with the degradation of various input parameters accounted for.

### DETAILED DESCRIPTION

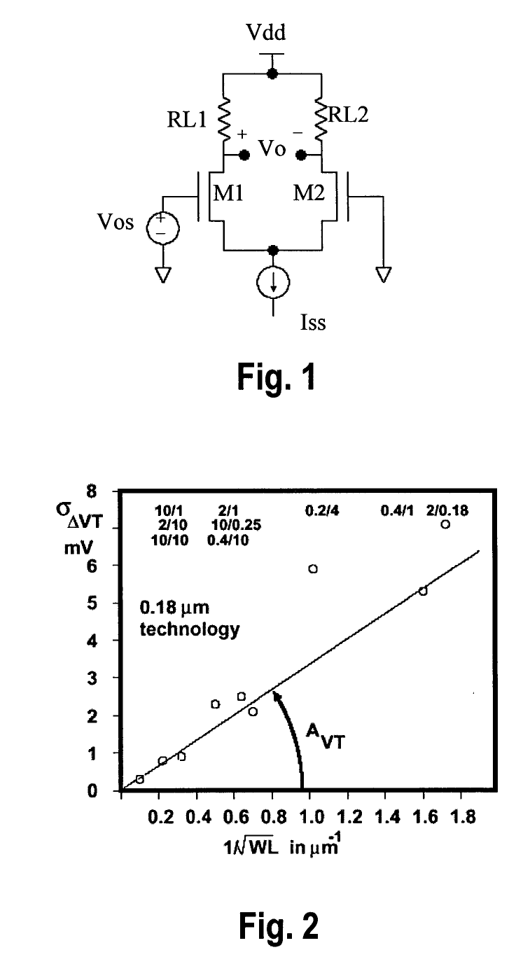

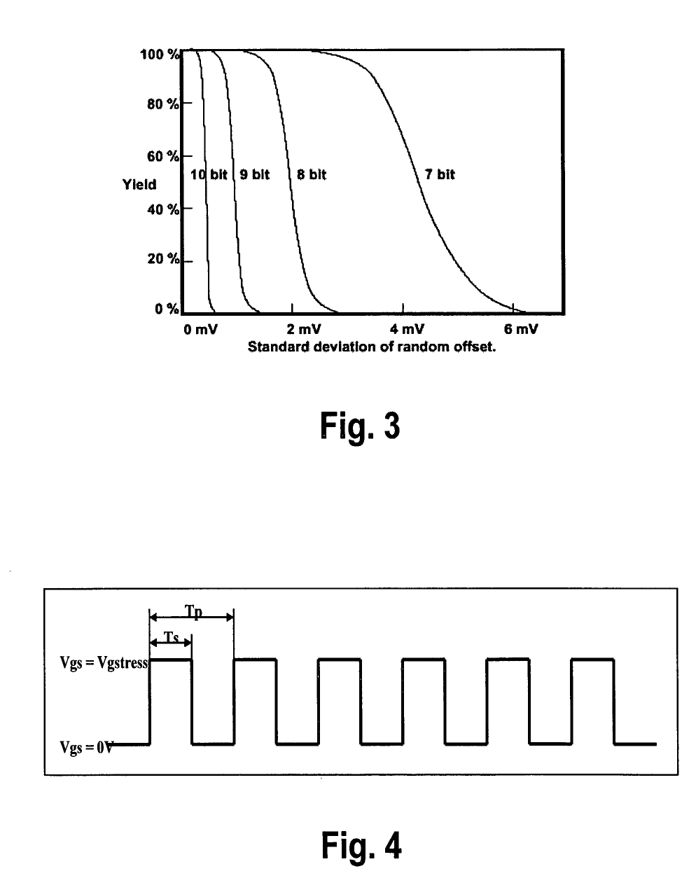

FIG. 1 depicts a schematic of an MOS source coupled pair, an essential component of analog CMOS design. Vₒₛ is defined as the differential input voltage that is required to make the differential output voltage exactly zero. The MOS transistor has an inherent threshold voltage mismatch. FIG. 2 shows a plot of NMOS threshold voltage matching (Vₜ) gate length and width properties for a 0.18 μm 33 nanometer process. FIG. 3 shows the yield of a 7 to 10 bit analog to digital converter as a function of the standard deviation of the input transistor pair mismatch. For a PMOS device, the negative bias temperature instability effect should be added to the offset voltage. As depicted, the negative bias temperature instability tends to have a relatively large effect on the function of a PMOS source coupled MOSFET pair where one of the devices is biased under negative bias temperature instability stress conditions while the other is not.

For example, if Δ is the difference and each value is the average of the parameter for devices M₁ and M₂, then:

ΔVₜ=Vₜ₁−Vₜ₂

Vₜ=(Vₜ₁+Vₜ₂)/2

Vₒₛ=ΔVₜ+(V_{gs}−Vₜ)/2 {(−ΔR₁/R_{L})−(−Δ(W/L)/(W/L))

Where Vₒₛ=offset voltage, R_{L} is the load resistance, W and L are the MOS gate width and length.

For some recent I/O circuit industry standards, comparators are used where one side of the differential pair is set to a direct current input reference voltage, the other is the input signal. The Vₜ shift on the reference voltage input is critical to the operation of the circuit.

The MOS transistor has an inherent threshold voltage mismatch caused by independent random disturbances of physical properties. FIG. 2 shows a typical curve for NMOS Vₜ matching versus (WL)^{-1/2} for a 0.18 μm (3.3 nm gate oxide) process. The slope of this curve, A_{VT}, depends on gate thickness and statistical variation in channel dopant density. FIG. 3 shows the effect of random Vₜ offset on a series of 7 to 10 bit analog to digital converters. As seen, it is not a viable option to build A-D converters using PMOS devices in the input stage transistor pair if Vₜ shifts during operation due to the negative bias temperature instability effect.

The direct current effect of parameter degradation as a result of the negative bias temperature instability effect can be modeled by the following equation:

Change in parameter value=At^{m} exp(−Ea/kT)exp(bV_{g})

The parameters A, m, −Ea, and b are constants for the effect of time, temperature, and gate voltage on parametric shift, obtained by curve fitting to the data. Ea is the activation energy, k is Boltzmann's constant, and t, T and V_{g} are time, temperature and gate voltage respectively.

The MOS threshold voltage, Vₜ, the MOS mobility, U₀, and the Idsat are preferably all included as parameters that shift under negative bias temperature instability stress. It is found that MOS device parameters U₀ and Idsat fit the negative bias temperature instability equation given above as well as Vₜ. This enables the modification of the equivalent Vₜ and U₀ fit parameters in a circuit simulator such as SPICE, so as to predict circuit performance in a manner that accounts for the effects of the parametric degradation of negative bias temperature instability.

With reference to FIG. 4, the following definitions are made:

Duty Cycle, R, R=Tₛ/Tₚ

Frequency, f f=1/Tₚ

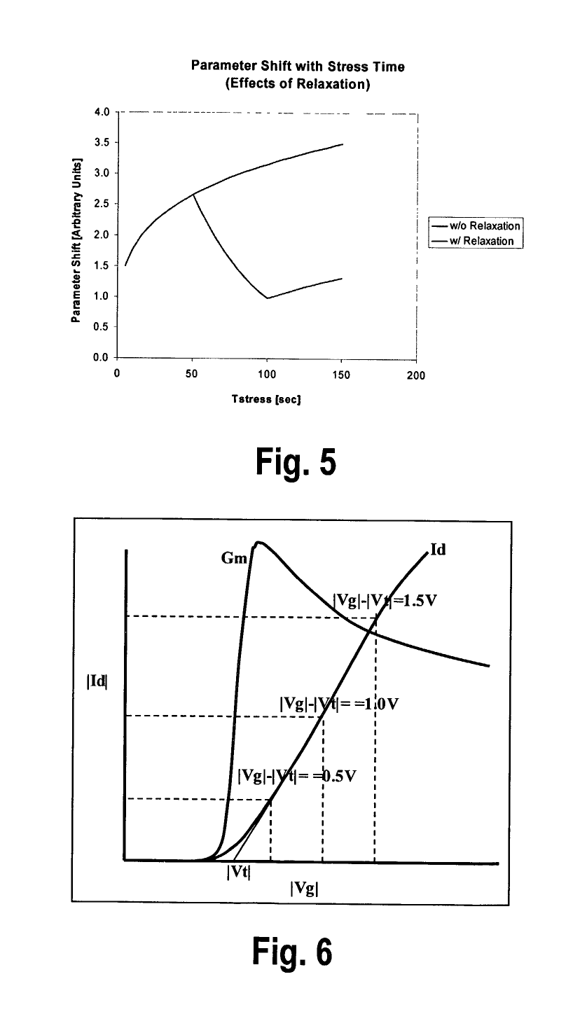

The parameter shifted by the negative bias temperature instability effect tends to relax back towards its original value once the stress is removed. This effect and the means to model the relaxation are demonstrated in FIG. 5. The negative bias temperature instability effect of frequency and duty cycle for alternating current devices (or for direct current devices where R=1) can be modeled with the following equation:

$$Parametric\_shift = a \cdot \frac{1}{{f}^{α \cdot {( 1 - R )}^{β}}} \cdot {t}^{m} \cdot exp ( - \frac{{E}_{A}}{kT} ) \cdot exp ( b \cdot Vg )$$

Constants α and β are preferably found by curve fitting the data once the effect of frequency, f, and duty cycle, R, are included in the characterization. This equation predicts that parameter shift is inversely proportional to frequency and proportional to duty cycle. With R=1, which is the direct current case, the parametric shift should be independent of frequency. The equation is convenient, because the frequency and the duty cycle only affect the main constant in the equation. Thus, the effects of gate voltage, temperature and time can be characterized independently of frequency and duty cycle.

One goal of Vₜ and Uₒ degradation modeling as described herein is to develop the analytical model to be used in circuit simulators, such as SPICE, to predict the actual circuit performance degradation. As dictated by the physics of negative bias temperature instability degradation, all the capacitance components should be unchanged. With this as a basis, the Vₜ and Idsat shifts caused by negative bias temperature instability stress can be predicted.

Vₜ shift is relatively easy to model because Vₜ is one of the fundamental transistor parameters that can be measured directly. The model for Vₜ shift of one of the transistor types in silicon is as follows:

$$Vtshift [ mV ] = A \cdot {t}^{m} \cdot exp ( - \frac{{E}_{a}}{kT} ) \cdot exp ( B \cdot Vg )$$

$$t \text{:} stress time in min .$$

The parameters for Vₜ shift are as follows:

A: 38.11 [mV]

m: 0.101

Ea: 0.09 [eV]

B: 0.562 [1/V]

Idsat degradation calculations tend to be somewhat more complicated than those for Vₜ degradation, because Idsat is typically determined based upon a combination of several circuit simulation model parameters. To predict the Idsat degradation through a SPICE model, for example, a sophisticated model for mobility degradation is preferred.

The Idsat (drive current) can be expressed as follows:

$${I}_{D} = μ {C}_{OX} \frac{W}{L} ( {V}_{G} - {V}_{T} - \frac{1}{2} {V}_{D} ) \cdot {V}_{D}$$

As shown in the equation above, the mobility term is preferably modeled with the Vₜ shift model in order to model Idsat shift. The equation for mobility definition in BSIM3 is as follows:

$${μ}_{i} \cdot {C}_{OX} = \frac{{U}_{0} \cdot {C}_{OX}}{1 + [ ( {V}_{G} - {V}_{T} ) \cdot \frac{{U}_{A}}{{T}_{OX}} + {( {V}_{G} - {V}_{T} )}^{2} \cdot \frac{{U}_{B}}{{T}_{OX}^{2}} ]}$$

In BSIM3, it is preferable to have the analytical expressions for Uₒ, Uₐ, and U_{b} as described above.

The methodology to get the measurement data for Uₒ, Uₐ, and U_{b} is given below. This is the methodology used to characterize the mobility terms. To get the three mobility parameters, at least three sets of Idsat data are preferably measured.

$${I}_{D1} = {μ}_{1} {C}_{OX} \frac{W}{L} {V}_{D} ( {V}_{G} - {V}_{T} ) : {V}_{D} = - 0.1 V , {V}_{GT1} = \vert {V}_{G} \vert - \vert {V}_{T} \vert = 0.5 V$$

$${I}_{D2} = {μ}_{2} {C}_{OX} \frac{W}{L} {V}_{D} ( {V}_{G} - {V}_{T} ) : {V}_{D} = - 0.1 V , {V}_{GT2} = \vert {V}_{G} \vert - \vert {V}_{T} \vert = 1.0 V$$

$${I}_{D3} = {μ}_{3} {C}_{OX} \frac{W}{L} {V}_{D} ( {V}_{G} - {V}_{T} ) : {V}_{D} = - 0.1 V , {V}_{GT3} = \vert {V}_{G} \vert - \vert {V}_{T} \vert = 1.5 V$$

The three bias points V_{g}−Vₜ=1.5V, 1.0V and 0.5V as depicted in FIG. 6 are preferably chosen. With these three data points, the three model parameters can be extracted with the following methodology. The mobility equation is rearranged as given below. The rearranged equation is the linear equation for three variables.

$${μ}_{i} \cdot {C}_{OX} = \frac{{U}_{0} \cdot {C}_{OX}}{1 + [ ( {V}_{G} - {V}_{T} ) \cdot \frac{{U}_{A}}{{T}_{OX}} + {( {V}_{G} - {V}_{T} )}^{2} \cdot \frac{{U}_{B}}{{T}_{OX}^{2}} ]}$$

μᵢ·C_{OX}=μᵢ·C_{OX}·V_{GTi}·U′_{A}+μᵢ·C_{OX}·V²_{GTi}U′_{B}=U₀·C_{OX}

If the indices are assigned to three data sets as 1, 2, and 3, the linear equations can be arranged as follows using matrix definitions:

$$[ \begin{matrix}1 & - {μ}_{1} \cdot {V}_{GT1} & - {μ}_{1} \cdot {V}_{GT1}^{2} \\ 1 & - {μ}_{2} \cdot {V}_{GT2} & - {μ}_{2} \cdot {V}_{GT2}^{2} \\ 1 & - {μ}_{3} \cdot {V}_{GT3} & - {μ}_{3} \cdot {V}_{GT3}^{2}\end{matrix} ] [ \begin{matrix}{U}_{0} \cdot {C}_{OX} \\ {U}_{A}^{′} \cdot {C}_{OX} \\ {U}_{B}^{′} \cdot {C}_{OX}\end{matrix} ] = [ \begin{matrix}{μ}_{1} \cdot {C}_{OX} \\ {μ}_{2} \cdot {C}_{OX} \\ {μ}_{3} \cdot {C}_{OX}\end{matrix} ]$$

where, U_{a′}=Uₐ/T_{OX} and U_{b′}=U_{b}/T_{OX}²

With inverse matrix algebra, each term of mobility equation can be expressed as follows:

$${U}_{0} {C}_{OX} = \frac{\begin{matrix}( {μ}_{1} {C}_{OX} ) ( {μ}_{2} {C}_{OX} ) ( {μ}_{3} {C}_{OX} ) [ ( {V}_{GT2} {V}_{GT3}^{2} - {V}_{GT2}^{2} {V}_{GT3} ) - \\ ( {V}_{GT1} {V}_{GT3}^{2} - {V}_{GT1}^{2} {V}_{GT3} ) + ( {V}_{GT1} {V}_{GT2}^{2} - {V}_{GT1}^{2} {V}_{GT2} ) ]\end{matrix}}{\begin{matrix}( {μ}_{2} {C}_{OX} ) ( {μ}_{3} {C}_{OX} ) [ {V}_{GT2} {V}_{GT3}^{2} - {V}_{GT2}^{2} {V}_{GT3} ] - \\ ( {μ}_{1} {C}_{OX} ) ( {μ}_{3} {C}_{OX} ) [ {V}_{GT1} {V}_{GT3}^{2} - {V}_{GT1}^{2} {V}_{GT3} ] + \\ ( {μ}_{1} {C}_{OX} ) ( {μ}_{2} {C}_{OX} ) [ {V}_{GT1} {V}_{GT2}^{2} - {V}_{GT1}^{2} {V}_{GT2} ]\end{matrix}}$$

$${U}_{A}^{′} = \frac{\begin{matrix}( {μ}_{2} {C}_{OX} ) ( {μ}_{3} {C}_{OX} ) [ {V}_{GT2}^{2} - {V}_{GT3}^{2} ] - \\ ( {μ}_{1} {C}_{OX} ) ( {μ}_{3} {C}_{OX} ) [ {V}_{GT1}^{2} {V}_{GT3}^{2} ] + \\ ( {μ}_{1} {C}_{OX} ) ( {μ}_{2} {C}_{OX} ) [ {V}_{GT1}^{2} - {V}_{GT2}^{2} ]\end{matrix}}{\begin{matrix}( {μ}_{2} {C}_{OX} ) ( {μ}_{3} {C}_{OX} ) [ {V}_{GT2} {V}_{GT3}^{2} - {V}_{GT2}^{2} {V}_{GT3} ] - \\ ( {μ}_{1} {C}_{OX} ) ( {μ}_{3} {C}_{OX} ) [ {V}_{GT1} {V}_{GT3}^{2} - {V}_{GT1}^{2} {V}_{GT3} ] + \\ ( {μ}_{1} {C}_{OX} ) ( {μ}_{2} {C}_{OX} ) [ {V}_{GT1} {V}_{GT2}^{2} - {V}_{GT1}^{2} {V}_{GT2} ]\end{matrix}}$$

$${U}_{B}^{′} {C}_{OX} = \frac{\begin{matrix}( {μ}_{2} {C}_{OX} ) ( {μ}_{3} {C}_{OX} ) [ {V}_{GT3} - {V}_{GT2} ] - \\ ( {μ}_{1} {C}_{OX} ) ( {μ}_{3} {C}_{OX} ) [ {V}_{GT3} - {V}_{GT1} ] + \\ ( {μ}_{1} {C}_{OX} ) ( {μ}_{2} {C}_{OX} ) [ {V}_{GT2} - {V}_{GT1} ]\end{matrix}}{\begin{matrix}( {μ}_{2} {C}_{OX} ) ( {μ}_{3} {C}_{OX} ) [ {V}_{GT2} {V}_{GT3}^{2} - {V}_{GT2}^{2} {V}_{GT3} ] - \\ ( {μ}_{1} {C}_{OX} ) ( {μ}_{3} {C}_{OX} ) [ {V}_{GT1} {V}_{GT3}^{2} - {V}_{GT1}^{2} {V}_{GT3} ] + \\ ( {μ}_{1} {C}_{OX} ) ( {μ}_{2} {C}_{OX} ) [ {V}_{GT1} {V}_{GT2}^{2} - {V}_{GT1}^{2} {V}_{GT2} ]\end{matrix}}$$

With the preset bias conditions, the expressions can be arranged as follows:

$${U}_{0} {C}_{OX} = \frac{- 0.25 ( {μ}_{1} {C}_{OX} ) ( {μ}_{2} {C}_{OX} ) ( {μ}_{3} {C}_{OX} )}{\begin{matrix}- 0.75 ( {μ}_{2} {C}_{OX} ) ( {μ}_{3} {C}_{OX} ) \\ + 0.75 ( {μ}_{1} {C}_{OX} ) ( {μ}_{3} {C}_{OX} ) \\ - 0.25 ( {μ}_{1} {C}_{OX} ) ( {μ}_{2} {C}_{OX} )\end{matrix}}$$

$${U}_{A}^{′} = \frac{\begin{matrix}- 1.25 ( {μ}_{2} {C}_{OX} ) ( {μ}_{3} {C}_{OX} ) + 2 ( {μ}_{1} {C}_{OX} ) ( {μ}_{3} {C}_{OX} ) \\ - 0.75 ( {μ}_{1} {C}_{OX} ) ( {μ}_{2} {C}_{OX} )\end{matrix}}{\begin{matrix}- 0.75 ( {μ}_{2} {C}_{OX} ) ( {μ}_{3} {C}_{OX} ) + 0.75 ( {μ}_{1} {C}_{OX} ) ( {μ}_{3} {C}_{OX} ) \\ - 0.25 ( {μ}_{1} {C}_{OX} ) ( {μ}_{2} {C}_{OX} )\end{matrix}}$$

$${U}_{B}^{′} {C}_{OX} = \frac{\begin{matrix}- 0.5 ( {μ}_{2} {C}_{OX} ) ( {μ}_{3} {C}_{OX} ) + ( {μ}_{1} {C}_{OX} ) ( {μ}_{3} {C}_{OX} ) \\ - 0.5 ( {μ}_{1} {C}_{OX} ) ( {μ}_{2} {C}_{OX} )\end{matrix}}{\begin{matrix}- 0.75 ( {μ}_{2} {C}_{OX} ) ( {μ}_{3} {C}_{OX} ) + 0.75 ( {μ}_{1} {C}_{OX} ) ( {μ}_{3} {C}_{OX} ) \\ - 0.25 ( {μ}_{1} {C}_{OX} ) ( {μ}_{2} {C}_{OX} )\end{matrix}}$$

The models for each mobility component are as follows:

$${U}_{0} {C}_{OX} [ \% ] = A \cdot {t}^{m} \cdot exp ( - \frac{{E}_{a}}{kT} ) \cdot exp ( B \cdot Vg )$$

t: stress time in min.

Where:

A: 1.16

m: 0.18

Ea: 0.081 [eV]

B: 0.597 [1/V].

$$\frac{{U}_{A}}{Tox} [ \% ] = A \cdot {t}^{m} \cdot exp ( - \frac{{E}_{a}}{kT} ) \cdot exp ( B \cdot Vg )$$

t: stress time in mm.

Where:

A: 1.09

m: 0.18

Ea: 0.019 [eV]

B: 0.541 [1/V].

$$\frac{{U}_{B}}{{Tox}^{2}} [ \% ] = A \cdot {t}^{m} \cdot exp ( - \frac{{E}_{a}}{kT} ) \cdot exp ( B \cdot Vg )$$

Where:

A: 2.93

m: 0.18

Ea: 0.067 [eV]

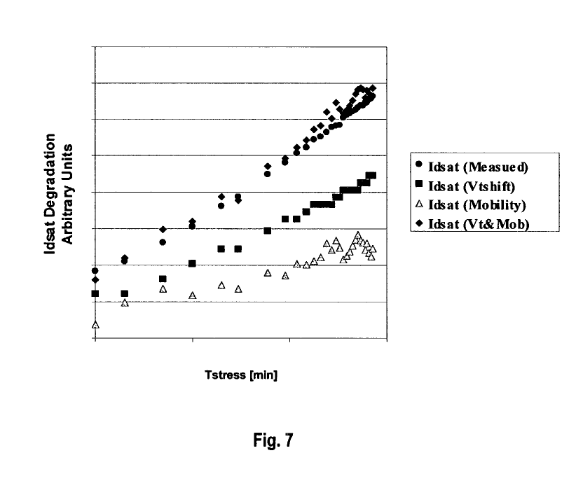

The actual application to predict Idsat degradation is described in FIG. 7. In this plot, the calculation results are compared with measured Idsat degradation. As shown, by including the Vₜ and mobility degradation models, the Idsat degradation is predicted accurately.

For the Vₜ shift model, using the following equation:

$$Parametric\_shift = a \cdot \frac{1}{{f}^{α \cdot {( 1 - R )}^{β}}} \cdot {t}^{m} \cdot exp ( - \frac{{E}_{A}}{kT} ) \cdot exp ( b \cdot Vg )$$

Where:

A: 44.6174

α: 0.14

β: 0.49

m: 0.12

Ea: 0.104 [eV]

B: 0.52 [IN].

The model parameters are obtained from curve fitting with various ranges of measurement conditions. With this modified degradation model, the circuit performance can be predicted such as by using the SPICE circuit simulator.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. In a method of modeling an integrated circuit, the improvement comprising accounting for the negative bias temperature instability effects of both threshold voltage and carrier mobility on Idsat.

2. The method of claim 1 wherein the integrated circuit is an alternating current device and the negative bias temperature instability effects are calculated according to:
$$Parametric\_shift = a \cdot \frac{1}{{f}^{α \cdot {( 1 - R )}^{β}}} \cdot {t}^{m} \cdot exp ( - \frac{{E}_{A}}{kT} ) \cdot exp ( b \cdot Vg )$$
where a, m, −Ea, and b are constants for effects of time, temperature, and gate voltage on parametric shift, obtained by curve fitting to empirical data, Ea is activation energy, k is Boltzmann's constant, and t, T and V_{g} are time, temperature and gate voltage respectively, and f and R are frequency and duty cycle respectively.

3. The method of claim 1 wherein the integrated circuit is a direct current device and the negative bias temperature instability effects are calculated according to:
$$Parametric\_shift = a \cdot {t}^{m} \cdot exp ( - \frac{{E}_{A}}{kT} ) \cdot exp ( b \cdot Vg )$$
where a, m, −Ea, and b are constants for effects of time, temperature, and gate voltage on parametric shift, obtained by curve fitting to empirical data, Ea is activation energy, k is Boltzmann's constant, and t, T and V_{g} are time, temperature and gate voltage respectively.
